(19) United States
(12) Patent Application Publication
(10) Pub. No.: US 2014/0152925 A1
(43) Pub. Date: Jun. 5, 2014

(54) LIQUID CRYSTAL LENS MODULE AND 3D DISPLAY DEVICE

(71) Applicant: BOE Technology Group Co., LTD., Beijing (CN)

(72) Inventor: Yanbing Wu, Beijing (CN)

(73) Assignee: BOE Technology Group Co., LTD., Beijing (CN)

(21) Appl. No.: 14/095,076

(22) Filed: Dec. 3, 2013

(30) Foreign Application Priority Data
Dec. 4, 2012 (CN) 201210513983.X

(51) Int. Cl. G02B 27/22

(52) U.S. Cl. CPC G02B 27/2214
USPC 349/15; 349/200

(57) ABSTRACT

Disclosed is a liquid crystal lens module, comprising a liquid crystal lens; a first polarizing sheet located at a lower surface of the liquid crystal lens; and a second polarizing sheet located at an upper surface of the liquid crystal lens, wherein the polarizing axis of the first polarizing sheet is parallel with that of the second polarizing sheet. Because of different orientations and horizontal twisting and the like of the liquid crystal molecules within the liquid crystal lens, polarizing direction of some of the polarized light transmitting through the first polarizing sheet, after being converged by the liquid crystal lens, may be changed, while the second polarizing sheet may filter out the polarized light whose polarizing direction has been changed, thus the crosstalk of the liquid crystal lens during a 3D display, caused by the polarized light whose polarizing direction has been changed, is reduced.

### CROSS-REFERENCE TO RELATED APPLICATION

This application claims the benefit of Chinese Patent Application No. 201210513983.X filed on Dec. 4, 2012 in the State Intellectual Property Office of China, the whole disclosure of which is incorporated herein by reference.

### BACKGROUND OF THE INVENTION

1. Field of the Invention

The present invention relates to the field of 3D (three-dimensional) display technology, and particularly to a liquid crystal lens module and a 3D display device.

2. Description of the Related Art

In everyday life, people use two eyes to observe outside 3D objects surrounding them. Three-dimensional (3D) display technology makes people get a sense of 3D space by means of binocular stereo vision principle. The main principle of the 3D display technology is to make the right eye and the left eye of the observer receive different images, and because of a position difference resulted from a pupillary distance between two eyes f the observer, two images having binocular parallax form a pair of 3D images which, after analysis and fusion via the observer' s brain, represent a 3D sense to the observer.

Currently, 3D display technology is mainly divided into two categories: a naked-eye type 3D display and a glasses type 3D display. To obtain the so-called naked-eye type 3D display, the screen of a monitor is specially processed so that light from encoded 3D video images enters the right eye and the left eye of the observer respectively, in this way, with naked eyes, the observer may have a 3D sense without the help of 3D glasses.

So far, to achieve naked-eye 3D display, a shield, such as a light barrier grid or a lens grating is provided in front of a light source array, for example, a liquid crystal display (LCD). And as shown in FIG. 1, with the light emitted from the display device being converged towards the focus of lens in the lens grating, the light emitted from left-eye pixels is directed to a left-eye viewing area of the observer, and the light emitted from right-eye pixels is directed to a right-eye viewing area, thus a 3D display effect is achieved.

Specifically, in order to achieve 3D display, one solution in the prior art is to provide a layer of liquid crystal lenses to the screen. As shown in FIG. 2, the liquid crystal lens comprises an upper substrate 21, a lower substrate 22 and a liquid crystal layer 23 therebetween, wherein the upper substrate 21 and the lower substrate 22 are provided with a strip electrode 24 and a surface electrode 25. In a 3D display mode, strip electrodes at different positions are supplied with different voltages so that different electric field strengths are produced, in this way, corresponding liquid crystal molecules are deflected by different degrees respectively, and thus the liquid crystal layer represents a lens effect.

In the structure of the liquid crystal lens grating shown in FIG. 2, when there is a large gap for example, greater than 30 μm, between adjacent strip electrodes, the orientation of the liquid crystal molecule between the adjacent strip electrodes will be inconsistent with the orientation of the liquid crystal molecules in other region. Furthermore, when signals of different voltages are provided between adjacent strip electrodes, a horizontal electric field is generated between the two strip electrodes, and the horizontal electric field will have an effect on and thus deflect the liquid crystal molecule between the two strip electrodes. As shown in FIG. 3, the broken line is indicated as a normal orientation of the liquid crystal molecule. However, because of the horizontal electric field generated between different voltages V1 and V2, as indicated by the solid line, the liquid crystal molecule will be slightly deflected. The liquid crystal molecules having different orientations may introduce crosstalk of the liquid crystal lens, that is, because of the abnormal orientation of the liquid crystal molecule, the light emitted from the right-eye pixels of the display device will be directed to the left-eye viewing area of the observer, and the light emitted from the left-eye pixels of the display device will be directed to the right-eye viewing area of the observer. The crosstalk will adversely affect the 3D display performance.

Therefore, how to reduce crosstalk in the liquid crystal lens during a 3D display is a critical problem to be solved in the art.

### SUMMARY OF THE INVENTION

The present invention has been made to overcome or alleviate at least one aspect of the above mentioned disadvantages.

The embodiments of the present invention provide a liquid crystal lens module and a 3D display device which may reduce or remove crosstalk of the liquid crystal grating in the prior art during a 3D display.

According to an aspect of the present invention, there is provided a liquid crystal lens module, comprising: a liquid crystal lens; a first polarizing sheet located at a lower surface of the liquid crystal lens; and a second polarizing sheet located at an upper surface of the liquid crystal lens, wherein the polarizing axis of the first polarizing sheet is parallel with that of the second polarizing sheet.

According to another aspect of the present invention, a 3D display device is provided. The 3D display device includes a display and the above liquid crystal lens module provided to the display.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic view showing a conventional lens-type 3D display.

FIG. 2 is a structural schematic view of a liquid crystal lens in the prior art.

FIG. 3 a schematic view showing the orientation of a crystal liquid molecule of a liquid crystal lens between strip electrodes.

FIG. 4 is a structural schematic view of a liquid crystal lens module according to an exemplary embodiment of the present invention.

FIG. 5 is a structural schematic view of a 3D display device according to an exemplary embodiment of the present invention.

FIGS. 6a-6b are structural schematic views of a liquid crystal lens according to a first embodiment of the present invention.

FIGS. 7a-7b are partially enlarged schematic views showing the structure of a liquid crystal lens according to a second embodiment of the present invention.

FIGS. 8a-8b are partially enlarged schematic views showing the structure of a liquid crystal lens according to a third embodiment of the present invention.

FIGS. 9a-9b are partially enlarged schematic views showing the structure of a liquid crystal lens according to a fourth embodiment of the present invention.

FIGS. 10a-10b are partially enlarged schematic views showing the structure of a liquid crystal lens according to a fifth embodiment of the present invention.

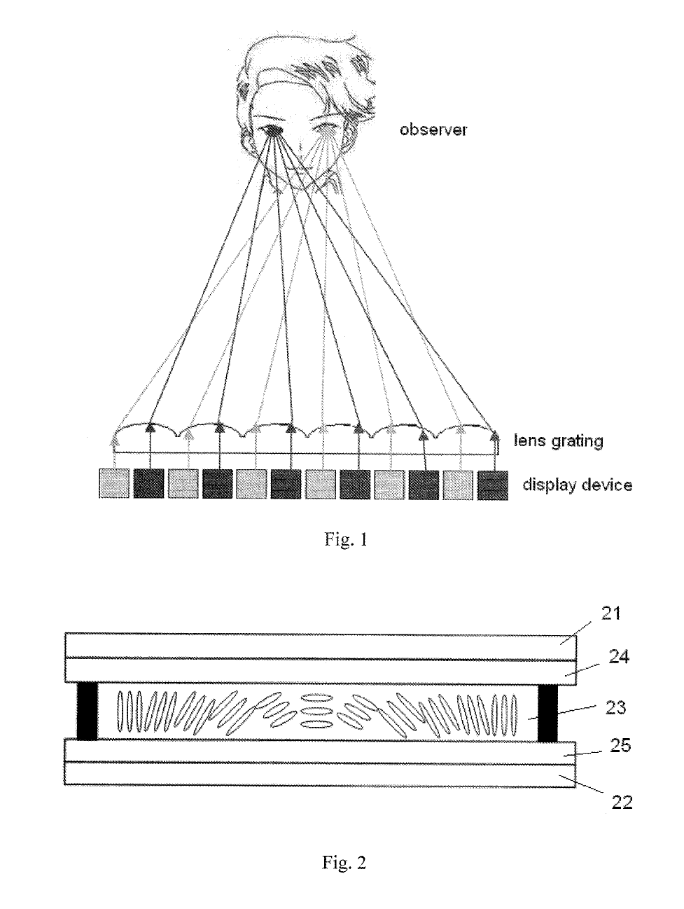

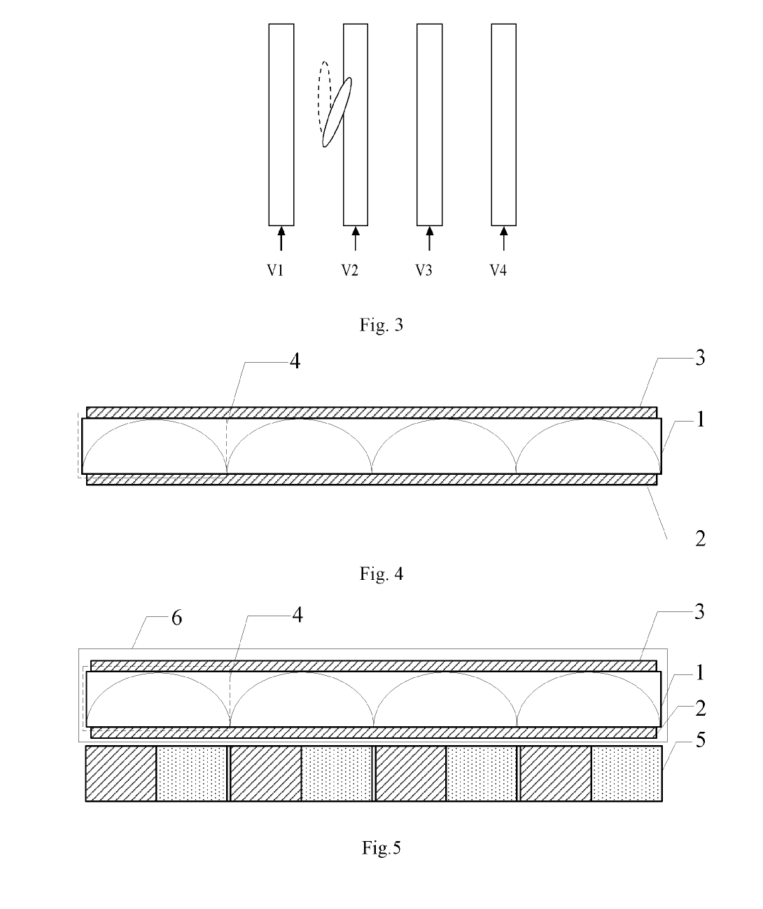

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the attached drawings, the thickness, area sizes and shapes of respective layers are just shown for the purpose of illustration of the invention and do not reflect the true proportion of liquid crystal lens module.

As shown in FIG. 4, a liquid crystal lens module according to an exemplary embodiment of the present invention comprises a liquid crystal lens 1; a first polarizing sheet 2 located at a lower surface of the liquid crystal lens 1; and a second polarizing sheet 3 located at an upper surface of the liquid crystal lens 1, wherein the polarizing axis of the first polarizing sheet 2 is parallel with that of the second polarizing sheet 3. The polarized light whose polarizing direction is parallel with the polarizing axis may transmit through the polarizing sheet, and a direction parallel with the polarizing axis is a light-transmission axis direction.

Because of different orientations and horizontal twisting and the like of the liquid crystal molecules within the liquid crystal lens, polarizing direction of some of the polarized light transmitting through the first polarizing sheet, after being converged by the liquid crystal lens, may be changed, while the second polarizing sheet may filter out the polarized light whose polarizing direction has been changed, thus the crosstalk of the liquid crystal lens during a 3D display, caused by the polarized light whose polarizing direction has been changed, is reduced.

To be more specific, as shown in FIG. 4, the liquid crystal lens 1 is usually provided with a plurality of lens units 4, and in a 3D display mode, each of the lens units 4 has a lens effect on the polarized light transmitting through the first polarizing sheet 2 so as to direct the light emitted from left-eye pixels towards a left-eye viewing area of an observer and to direct the light emitted from right-eye pixels towards a right-eye viewing area of the observer, to achieve a 3D display effect.

According to an exemplary embodiment of the present invention, a 3D display device is provided. As shown in FIG. 5, the 3D display device comprises a display 5 and the above liquid crystal lens module 6 which is provided to the display 5.

Generally, a single pixel unit in the display 5 is composed of three sub-pixels, such as red, green and blue sub-pixel units. In a 3D display mode, images displayed on odd-numbered sub-pixel columns are left-eye images, and images displayed on even-numbered sub-pixel columns are right-eye images. Alternatively, n sub-pixel columns may be ordered as a cycle, and the left-eye images and the right-eye images are arranged alternately. Such an alternative solution is not specifically defined herein.

To be more specific, each lens unit 4 in the liquid crystal lens 1 corresponds to two adjacent sub-pixel columns in the display 5, wherein one sub-pixel column displays the left-eye image, and the other sub-pixel column displays the right-eye image. For example, the Ni-th lens unit in the first liquid crystal lens 1 corresponds to the i-th sub-pixel unit of the display 5, thus, the images viewed by the left eye and the images viewed by the right eye are separated, and thus a 3D display is achieved.

In an specific embodiment, the display 5 may be a liquid crystal display panel, an organic electroluminescence display panel, a plasma display panel or a cathode ray tube display or the like, and the detailed description thereof is omitted.

In addition, when the 3D display device is applied to a liquid crystal display panel, since the liquid crystal display panel itself comprises a polarizing sheet, the first polarizing sheet under the liquid crystal lens in the liquid crystal lens module may be omitted, and the polarizing axis of the second polarizing sheet is provided to be parallel with a polarizing axis of the polarizing sheet in the liquid crystal display panel. Or alternatively, the polarizing sheet in the liquid crystal display panel is directly omitted.

Specifically, the liquid crystal lens module and the liquid crystal lens 1 in the 3D display device according to the embodiments of the present invention may have various structures. Next, the specific structure of the liquid crystal lens 1 will be described with respect to several exemplary embodiments.

### Embodiment 1

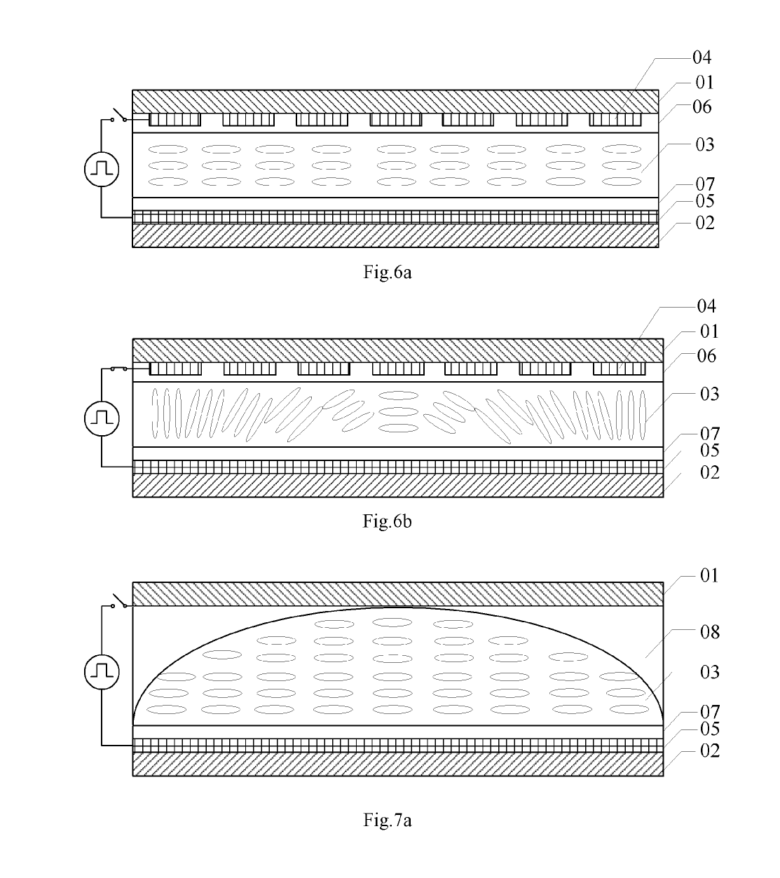

The liquid crystal lens 1 achieves a 2D (two-dimensional) display when no voltages are applied, and achieves a 3D display when the voltages are applied. The specific structure of the liquid crystal lens 1 is shown in FIG. 6a. The liquid crystal lens 1 comprises: an upper substrate 01; a lower substrate 02 arranged to be opposite to the upper substrate 01; a liquid crystal layer 03 between the upper and lower substrates 01, 02; a first transparent electrode 04 provided at a side of the upper substrate 01 facing the liquid crystal layer 03; a second transparent electrode 05 provided at a side of the lower substrate 02 facing the liquid crystal layer 03; a first alignment film 06 provided at a side of the first transparent electrode 04 facing the liquid crystal layer 03; and a second alignment film 07 provided at a side of the second transparent electrode 05 facing the liquid crystal layer 03.

In a 2D display mode, the first and second transparent electrodes 04, 05 are not supplied with voltages, the liquid crystal molecules in the liquid crystal lens 03 are arranged in parallel in a first direction (for example, the liquid crystal molecules in the liquid crystal lens 03 are arranged in a direction which is in parallel with a plane where the paper is located) so that the liquid crystal lens does not have an effect on the polarized light transmitting therethrough.

Specifically, the first transparent electrode 04 in this embodiment comprises a plurality of strip electrodes, and the second transparent electrode 5 is a surface electrode, as shown in FIG. 6a. Alternatively, the second transparent electrode 05 comprises a plurality of strip electrodes, and the first transparent electrode 04 is a surface electrode.

In a 3D display mode, as shown in FIG. 6b, voltages are supplied to the first and second transparent electrodes 04, 05 to generate an electric field which deflects the liquid crystal molecules in the liquid crystal layer corresponding to each lens unit to form a convex lens effect, so that the polarized light is modulated and the polarized light which has been modulated is converged at the focus of the formed convex lens, and FIG. 6b is a schematic view showing a turned state of the liquid crystal molecules in one lens unit.

### Embodiment 2

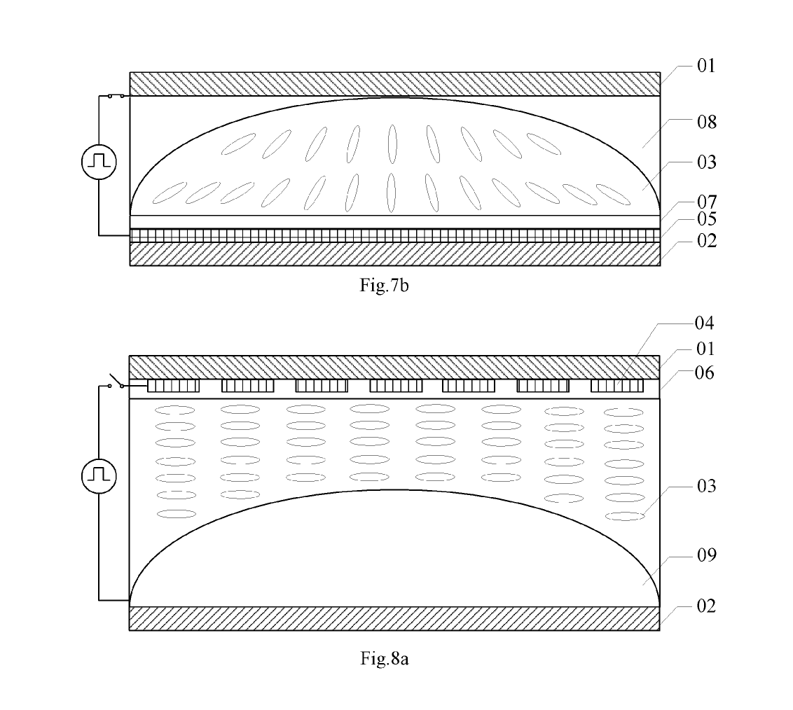

The liquid crystal lens 1 achieves a 3D display when no voltages are applied, and achieves a 2D display when the voltages are applied. The specific structure of the liquid crystal lens 1 is shown in FIG. 7a. In addition to the structure shown in FIGS. 6a and 6b, the liquid crystal lens 1 further comprises a lens layer 08 having a concave lens structure, the lens layer 08 being provided between the upper substrate 01 and the first transparent electrode or between the first transparent electrode and the first alignment film. In FIG. 7a, the first transparent electrode and the first alignment film are not shown.

In a 2D display mode, as shown in FIG. 7b, voltages are provided to the first and second transparent electrodes to generate an electric field which deflects the liquid crystal molecules in the liquid crystal layer corresponding to each lens unit to form a convex lens effect. The effect of the thus formed convex lens and the effect of the concave structure of the lens layer 08 cancel each other out, that is, the liquid lens 1 does not have an effect on the light transmitting theretrough.

In a 3D display mode, as shown in FIG. 7a, the first and second transparent electrodes 04, 05 are not supplied with voltages, the liquid crystal molecules in the liquid crystal layer 03 are arranged in parallel in the first direction, and thus liquid crystal layer 03 has no effect on the polarized light transmitting therethrough, while the polarized light transmitting through the lens layer 08 is modulated by it so that the modulated light is converged at the focus of the concave lens structure of the lens layer 08.

### Embodiment 3

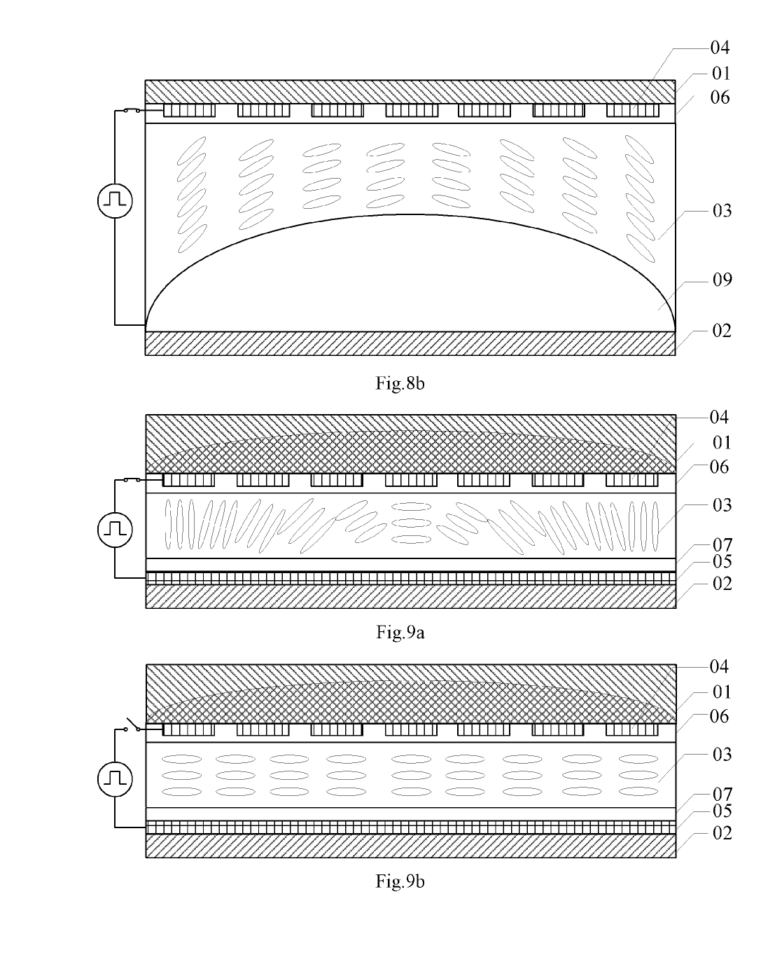

The liquid crystal lens 1 achieves a 3D display when no voltages are applied, and achieves a 2D display when the voltages are applied. The specific structure of the liquid crystal lens 1 is shown in FIG. 8a. In addition to the structure shown in FIGS. 6a and 6b, the liquid crystal lens 1 further comprises a lens layer 09 having a convex lens structure, the lens layer being provided between the lower substrate 02 and the second transparent electrode or between the second transparent electrode and the second alignment film. The second alignment film and the second transparent electrode are not shown in FIG. 8a.

In a 2D display mode, as shown in FIG. 8b, voltages are applied to the first and second transparent electrodes 04,05 to generate an electric field which deflects the liquid crystal molecules in the liquid crystal layer 03 corresponding to each lens unit to form a concave lens effect. The effect of the thus formed concave lens and the effect of the convex structure of the lens layer 09 cancel each other out, that is, the liquid lens 1 does not have an effect on the light transmitting theretrough.

In a 3D display mode, as shown in FIG. 8a, the first and second transparent electrodes 04, 05 are not applied with voltages, the liquid crystal molecules in the liquid crystal layer 03 are arranged in parallel in the first direction, and thus liquid crystal layer 03 has no effect on the polarized light transmitting therethrough, while the polarized light transmitting through the lens layer 09 is modulated by it so that the modulated light is converged at the focus of the convex lens structure of the lens layer 09.

### Embodiment 4

The liquid crystal lens 1 achieves a 3D display when no voltages are applied, and achieves a 2D display when the voltages are applied. The specific structure of the liquid crystal lens 1 is shown in FIG. 9a. In addition to the structure shown in FIGS. 6a and 6b, the liquid crystal lens 1 further comprises a concave lens structure provided at a side of the upper substrate away from or facing the liquid crystal layer, for example, as shown in FIG. 9a, the concave lens structure is provided at a side of the upper substrate 01 away from the liquid crystal layer 03.

In a 2D display mode, as shown in FIG. 9a, voltages are provided to the first and second transparent electrodes 04,05 to generate an electric field which deflects the liquid crystal molecules in the liquid crystal layer 03 corresponding to each lens unit to form a convex lens effect. The effect of the thus formed convex lens and the effect of the concave structure at the upper substrate 01 cancel each other out, that is, the liquid lens 1 does not have an effect on the light transmitting theretrough.

In a 3D display mode, as shown in FIG. 9b, the first and second transparent electrodes 04, 05 are not supplied with voltages, the liquid crystal molecules in the liquid crystal layer 03 are arranged in parallel in the first direction, and thus liquid crystal layer 03 has no effect on the polarized light transmitting therethrough, while the polarized light transmitting therethrough is modulated by the concave lens structure at the upper substrate 01 so that the modulated light is converged at the focus of the concave lens structure.

### Embodiment 5

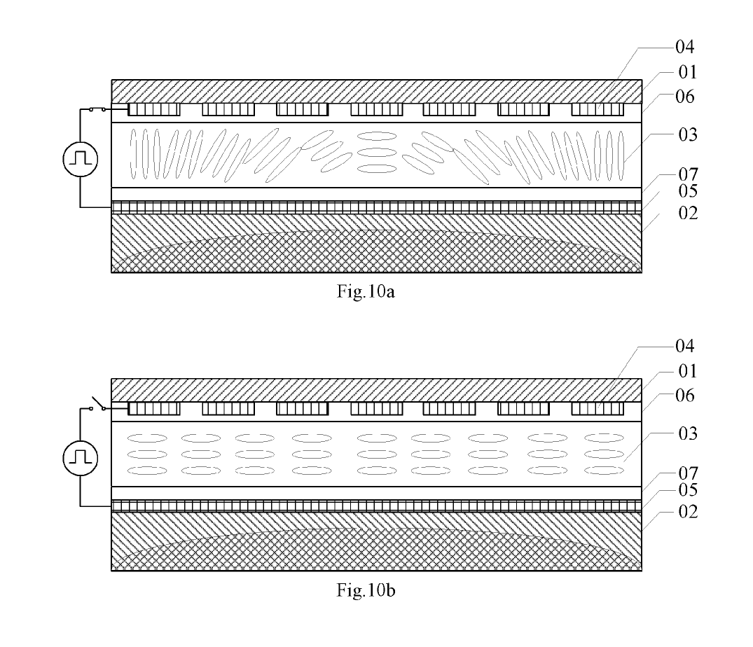

The liquid crystal lens 1 achieves a 3D display when no voltages are applied, and achieves a 2D display when the voltages are applied. The specific structure of the liquid crystal lens 1 is shown in FIG. 10a. In addition to the structure shown in FIGS. 6a and 6b, the liquid crystal lens 1 further comprises a convex lens structure provided at a side of the lower substrate 02 away from or facing the liquid crystal layer, for example, as shown in FIG. 10a, the convex lens structure is provided at a side of the lower substrate 02 away from the liquid crystal layer 03.

In a 2D display mode, as shown in FIG. 10a, voltages are provided to the first and second transparent electrodes to generate an electric field which deflects the liquid crystal molecules in the liquid crystal layer 03 corresponding to each lens unit to form a concave lens effect. The effect of the thus formed concave lens and the effect of the convex structure at the lower substrate 02 cancel each other out, that is, the liquid lens 1 does not have an effect on the light transmitting theretrough.

In a 3D display mode, as shown in FIG. 10b, the first and second transparent electrodes 04, 05 are not supplied with voltages, the liquid crystal molecules in the liquid crystal layer 03 are arranged in parallel in the first direction, and thus liquid crystal layer 03 has no effect on the polarized light transmitting therethrough, while the polarized light transmitting therethrough is modulated by the convex lens structure at the lower substrate 02 so that the modulated light is converged at the focus of the convex lens structure.

According to an exemplary embodiment of the present invention, a 3D display device is provided, the 3D display device comprises the above liquid crystal lens module, wherein the first and second polarizing sheets are provided respectively at the lower surface and the upper surface of the liquid crystal lens, and the polarizing axis of the first polarizing sheet is parallel with that of the second polarizing sheet. Because of different orientations and horizontal twisting and the like of the liquid crystal molecules within the liquid crystal lens, polarizing direction of some of the polarized light transmitting through the first polarizing sheet, after being converged by the liquid crystal lens, may be changed, while the second polarizing sheet may filter out the polarized light whose polarizing direction has been changed, thus the crosstalk of the liquid crystal lens during a 3D display, caused by the polarized light whose polarizing direction has been changed, is reduced.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A liquid crystal lens module, comprising:
a liquid crystal lens;
a first polarizing sheet located at a lower surface of the liquid crystal lens; and
a second polarizing sheet located at an upper surface of the liquid crystal lens,
wherein a polarizing axis of the first polarizing sheet is parallel with that of the second polarizing sheet.

2. The liquid crystal lens module of claim 1, wherein the liquid crystal lens is provided with a plurality of lens units, and in a 3D display mode, each of the lens units has a lens effect on polarized light transmitting through the first polarizing sheet so as to direct the light emitted from left-eye pixels towards a left-eye viewing area of an observer and to direct the light emitted from right-eye pixels towards a right-eye viewing area of the observer.

3. The liquid crystal lens module of claim 2, wherein the liquid crystal lens comprises:
an upper substrate;
a lower substrate arranged to be opposite to the upper substrate;
a liquid crystal layer between the upper and lower substrates;
a first transparent electrode provided at a side of the upper substrate facing the liquid crystal layer;
a second transparent electrode provided at a side of the lower substrate facing the liquid crystal layer;
a first alignment film provided at a side of the first transparent electrode facing the liquid crystal layer; and
a second alignment film provided at a side of the second transparent electrode facing the liquid crystal layer.

4. The liquid crystal lens module of claim 3, wherein
one of the first and second transparent electrodes is a strip electrode, and the other of the first and second transparent electrodes is a surface electrode, and
in the 3D display mode, voltages are supplied to the first and second transparent electrodes to generate an electric field which deflects the liquid crystal molecules in the liquid crystal layer corresponding to each lens unit to form a convex lens effect.

5. The liquid crystal lens module of claim 3, wherein
the liquid crystal lens further comprises a lens layer having a concave lens structure, the lens layer being provided between the upper substrate and the first transparent electrode or between the first transparent electrode and the first alignment film, and
in a 2D display mode, voltages are provided to the first and second transparent electrodes to generate an electric field which deflects the liquid crystal molecules in the liquid crystal layer corresponding to each lens unit to form a convex lens effect.

6. The liquid crystal lens of claim 3, wherein
the liquid crystal lens further comprises a lens layer having a convex lens structure, the lens layer being provided between the lower substrate and the second transparent electrode or between the second transparent electrode and the second alignment film, and
in a 2D display mode, voltages are provided to the first and second transparent electrodes to generate an electric field which deflects the liquid crystal molecules in the liquid crystal layer corresponding to each lens unit to form a concave lens effect.

7. The liquid crystal lens of claim 3, wherein
a side of the upper substrate away from or facing the liquid crystal layer is provided with a concave lens structure, and
in a 2D display mode, voltages are provided to the first and second transparent electrodes to generate an electric field which deflects the liquid crystal molecules in the liquid crystal layer corresponding to each lens unit to form a convex lens effect.

8. The liquid crystal lens of claim 3, wherein
a side of the lower substrate away from or facing the liquid crystal layer is provided with a convex lens structure, and
in a 2D display mode, voltages are provided to the first and second transparent electrodes to generate an electric field which deflects the liquid crystal molecules in the liquid crystal layer corresponding to each lens unit to form a concave lens effect.

9. A 3D display device, comprising:
a display; and
a liquid crystal lens module provided to the display, the liquid crystal lens module is the liquid crystal lens module of claim 1.

10. The 3D display device of claim 9, wherein each lens unit in the liquid crystal lens of the liquid crystal lens module corresponds to two adjacent columns of sub-pixel unit in the display, wherein one of the two adjacent columns displays a left-eye image, and the other of the two adjacent columns display a right-eye image.

11. The 3D display device of claim 9, wherein the display comprises a liquid crystal display panel, an organic electroluminescence display panel, a plasma display panel or a cathode ray tube display.

12. The 3D display device of claim 10, wherein the display comprises a liquid crystal display panel, an organic electroluminescence display panel, a plasma display panel or a cathode ray tube display.

13. The 3D display device of claim 9, wherein the liquid crystal lens is provided with a plurality of lens units, and in a 3D display mode, each lens unit has a lens effect on polarized light transmitting through the first polarizing sheet so as to direct the light emitted from left-eye pixels towards a left-eye viewing area of an observer and to direct the light emitted from right-eye pixels towards a right-eye viewing area of the observer.

14. The 3D display device of claim 9, wherein the liquid crystal lens comprises:
an upper substrate;
a lower substrate arranged to be opposite to the upper substrate;
a liquid crystal layer between the upper and lower substrates;
a first transparent electrode provided at a side of the upper substrate facing the liquid crystal layer;
a second transparent electrode provided at a side of the lower substrate facing the liquid crystal layer;
a first alignment film provided at a side of the first transparent electrode facing the liquid crystal layer; and
a second alignment film provided at a side of the second transparent electrode facing the liquid crystal layer.

15. The 3D display device of claim 14, wherein
one of the first and second transparent electrodes is a strip electrode, and the other of the first and second transparent electrodes is a surface electrode, and
in the 3D display mode, voltages are supplied to the first and second transparent electrodes to generate an electric field which deflects the liquid crystal molecules in the liquid crystal layer corresponding to each lens unit to form a convex lens effect.

16. The 3D display device of claim 14, wherein
the liquid crystal lens further comprises a lens layer having a concave lens structure, the lens layer being provided between the upper substrate and the first transparent electrode or between the first transparent electrode and the first alignment film, and
in a 2D display mode, voltages are provided to the first and second transparent electrodes to generate an electric field which deflects the liquid crystal molecules in the liquid crystal layer corresponding to each lens unit to form a convex lens effect.

17. The 3D display device of claim 14, wherein
the liquid crystal lens further comprises a lens layer having a convex lens structure, the lens layer being provided between the lower substrate and the second transparent electrode or between the second transparent electrode and the second alignment film, and
in a 2D display mode, voltages are provided to the first and second transparent electrodes to generate an electric field which deflects the liquid crystal molecules in the liquid crystal layer corresponding to each lens unit to form a concave lens effect.

18. The 3D display device of claim 14, wherein
a side of the upper substrate away from or facing the liquid crystal layer is provided with a concave lens structure, and
in a 2D display mode, voltages are provided to the first and second transparent electrodes to generate an electric field which deflects the liquid crystal molecules in the liquid crystal layer corresponding to each lens unit to form a convex lens effect.

19. The 3D display device of claim 14, wherein
a side of the lower substrate away from or facing the liquid crystal layer is provided with a convex lens structure, and
in a 2D display mode, voltages are provided to the first and second transparent electrodes to generate an electric field which deflects the liquid crystal molecules in the liquid crystal layer corresponding to each lens unit to form a concave lens effect.

20. The 3D display device of claim 9, wherein the display comprises a liquid crystal display panel, and a polarizing sheet of the liquid crystal display panel is the first polarizing sheet.
